(19) United States
(12) Patent Application Publication
(10) Pub. No.: US 2024/0243611 A1
(43) Pub. Date: Jul. 18, 2024

(54) POINT OF INTERFACE

(71) Applicant: TJ INNOVATION CO., LTD., Bucheon-si (KR)

(72) Inventors: Gwang-Jae JANG, Bucheon-si (KR); Jin-Kyu LEE, Bucheon-si (KR); Jun-A LEE, Bucheon-si (KR); Hyung-Gyu KIM, Bucheon-si (KR)

(21) Appl. No.: 17/767,997

(22) PCT Filed: Feb. 4, 2022
(86) PCT No.: PCT/KR2022/001777

§ 371 Date: Aug. 3, 2023

(30) Foreign Application Priority Data
Jan. 27, 2022 (KR) 10-2022-0011996

(51) Int. Cl. H02J 50/00; H02J 50/20; H04Q 1/28

(52) U.S. Cl. CPC H02J 50/001; H02J 50/20; H04Q 1/28

(57) ABSTRACT

Disclosed is a point of interface for connecting communication between a base station and a distributed antenna system, including: a power collection unit provided with first ports connected to the base station; and second ports connected to the distributed antenna system; and a battery management unit including a battery pack, wherein the power collection unit includes: a rectifier for rectifying a signal transmitted through the first ports; couplers for coupling the signal transmitted through the first ports to transmit an obtained sub RF signal to the second ports; and a charger for charging the battery pack with power using the rectified signal.

### TECHNICAL FIELD

The present disclosure relates to a Point Of Interface as a communication connection point between a Base Transceiver System (BTS) and a Distributed Antenna System (DAS).

### BACKGROUND ART

As the technology that can transmit various types of large-capacity data such as voice and data at high speed is recently required, a Distributed Antenna System (DAS) using a plurality of distributed antennas is being introduced so as to solve a shadow area or expand coverage.

DAS is a system using a single base station and multiple distributed antennas connected by wired or dedicated lines, a single base station. Here, the single base station manages a plurality of antennas located apart from each other by a predetermined distance or more within a cell serviced by the base station. In the case of DAS, a plurality of antennas are dispersed and located apart by a predetermined distance or more from each other within a cell, which differs from a centralized antenna system (CAS) in which a plurality of base station antennas are concentrated in the center of a cell in that.

DAS is distinguished from a femto cell in that, in the case of DAS, each unit of distributed antennas does not control the area of the corresponding antenna by itself, and a base station in the center of a cell controls all the distributed antenna areas located in the cell. In addition, DAS is distinguished from a multi-hop relay system or ad-hoc network wherein a base station and a remote station (RS) are wirelessly connected to each other in that, in the case of DAS, distributed antenna units are connected to each other by wired or dedicated lines. Further, DAS is distinguished from a repeater structure of simply amplifying and transmitting a signal in that, in the case of DAS, each of distributed antennas can transmit different signals to each terminal adjacent to each the antenna according to the command of a base station.

Such DAS may be considered as a type of multiple input multiple output (MIMO) system in that distributed antennas can simultaneously transmit and receive different data streams to support single or multiple mobile stations. In the view of the MIMO system, DAS has a reduced transmission area for each antenna due to antennas distributed at various locations within a cell, compared to CAS, thereby reducing transmission power. In addition, DAS may reduce path loss by shortening a transmission distance between an antenna and a terminal to enable high-speed data transmission, thereby increasing the transmission capacity and power efficiency of a cellular system. Further, DAS may satisfy communication performance of relatively uniform quality, compared to CAS, regardless of the location of a user in a cell. In addition, DAS may have low signal loss and reduced correlation and interference among antennas because a base station and a plurality of distributed antennas are connected to each other by wired or dedicated lines, thereby having a high signal-to-interference-plus-noise ratio (SINR).

As such, DAS may reduce the cost of base station extension and backhaul network maintenance in the next-generation mobile communication system, and may be used together with existing CAS or instead of CAS so as to expand service coverage and improve channel capacity and SINR, thereby becoming a new basis for cellular communication.

FIG. 2 illustrates a block diagram of a general distributed antenna system. As shown in FIG. 2, a distributed antenna system 20 is disposed between a base station 1 and a User Equipment (UE) (not shown) connected to transmit an Up-Link (UL) signal to the base station 1 or to receive a Down-Link (DL) signal from the base station 1, thereby being capable of relaying a communication signal.

Specifically, the distributed antenna system 20 provided between the base station 1 and a terminal may include a Master Unit (MU) 21 and Service Units (SUs) 231 and 232.

The MU 21 is preferably connected with a wire (e.g., an optical cable) to be able to communicate with the base station 1 to relay a signal during communication the terminal and the base station 1 and amplify, shape, or adjust the timing of the signal as needed.

In addition, the SUs 231 and 232 are connected to be able to communicate with the terminal and are positioned between the base station 1 and the terminal or between the MU 21 and the terminal to relay a signal.

In addition, as needed, the distributed antenna system 20 may further include an Extension Unit (EU) 22 as a concentrator, i.e., a hub, for transmitting a signal between one MU 21 and several SUs 231 and 232 in both directions.

For example, in a building, one MU 21 connected to the base station 1 by a wire may be installed, and, additionally, a plurality of SUs 231 and 232 connected to a terminal; and the EU 25 disposed between the one MU 21 and the plural SUs 21 and 22 to distribute a communication signal may be provided. Here, SUs 21 and 22 are generally for each floor of a building.

Meanwhile, FIG. 1 is a block diagram illustrating a general state in which a Point Of Interface is installed. As shown in FIG. 1, a Point Of Interface (POI) 10 may be provided between a base station 1 and a distributed antenna system 20.

The POI 10 is provided for interworking and interconnection between the base station 1 and the distributed antenna system 20. Interworking and interconnection between the base station 1 and a repeater follows the CPRI method, the intermediate frequency (IF) method, the RF signal interworking method, or the like. In the case of the RF signal interworking method, an RF signal is directly received from an antenna port of the base station 1, and a high RF signal level of the base station 1 should be lowered using an attenuator such that a repeater can receive the high RF signal.

FIG. 3 illustrates a block diagram of an existing Point Of Interface (POI). As shown in FIG. 3, an existing POI 10 may include first ports 11a to 11d connected to communicate with a base station 1: and second ports 12a to 12d connected to communicate with a distributed antenna system 20. Here, couplers 13a to 13d for lowering the level of an RF signal introduced through the first ports 11a to 11d may be included.

The couplers 13a to 13d may couple an RF signal, introduced from the base station 1 through the first ports 11a to 11d and transmitted along the transmission paths 15a to 15d, without affecting the original signal, and thus, may provide to the distributed antenna system 20 through the second ports 12a to 12d. That is, the couplers 13a to 13d may divide a RF signal of high power (about +43 dbM) introduced through the first ports 11a to 11d into an RF signal of low power (about 0 dbM) to provide the divided low-power RF signal to the second ports 12a to 12d.

Here, since a high level signal is still transmitted even if an RF signal introduced through the first ports 11a to 11d and transmitted along the transmission paths 15a to 15d was partially distributed by the couplers 13a to 13d, heat is generated from impedances 14a to 14d provided at ends of the transmission paths 15a to 15d. To radiate the heat to the outside, the existing POI 10 is provided with a large-area heat sink (not shown).

Since most of RF signal k of high output passed through the couplers 13a to 13d is consumed as heat, the existing POI 10 increases the temperature of a space installed therewith. In addition, there is a limit in minimizing the POI 10 or reducing the manufacturing cost of the POI 10.

Therefore, there is an urgent need for development of technology to address the problems.

### DISCLOSURE

### Technical Problem

Therefore, the present disclosure has been made in view of the above problems, and it is an object of the present disclosure to provide a point of interface capable of collecting and utilizing energy using a high-output RF signal of a base station and thus improving energy consumption efficiency and preventing heat generation, thereby downsizing equipment.

### Technical Solution

In accordance with an aspect of the present disclosure, the above and other objects can be accomplished by the provision of a point of interface for connecting communication between a base station and a distributed antenna system, including: a power collection unit provided with first ports connected to the base station; and second ports connected to the distributed antenna system; and a battery management unit including a battery pack, wherein the power collection unit includes: a rectifier for rectifying a signal transmitted through the first ports; couplers for coupling the signal transmitted through the first ports to transmit an obtained sub RF signal to the second ports; and a charger for charging the battery pack with power using the rectified signal.

In accordance with an embodiment, the rectifier may include a plurality of rectifier elements for rectifying a main RF signal, other than the sub RF signal distributed by the couplers, among signals transmitted through the first ports to DC signals, and the power collection unit may include at least one signal distributer for distributing the main RF signal, which passes through the couplers, to the plural rectifier elements; and a combine element for summing the plural DC signals rectified by the plural rectifier elements.

In accordance with an embodiment, the power collection unit may be provided at a rear end of the couplers and may further include an signal isolator for allowing the main RF signal, which passes through the couplers, to proceed only in one direction.

In accordance with an embodiment, a plurality of distribution elements may be provided between the couplers and the plural rectifier elements such that the distribution elements are hierarchically connected to each other.

In accordance with an embodiment, the battery management unit may include: a first power input port inputted from the charger of the power collection unit; a second power input port to which power that is supplied to the base station and divided is inputted; a power output port for outputting power outward; and a power controller for selecting any one source of the battery pack, the first power input port and the second power input port and for supplying power of the selected source to the power output port.

In accordance with an embodiment, the power controller may select the source according to a charge level of the battery pack, whether the power collection unit is connected to the first power input port, and whether external power is inputted through the second power input port.

In accordance with an embodiment, when the charge level of the battery pack is less than a preset threshold value and power is inputted to the first power input port, the power controller may be driven using a portion of the power inputted to the first power input port and may charge the battery pack with another portion of the power, and the power controller may supply power inputted to the second power input port to the power output port.

In accordance with an embodiment, when the charge level of the battery pack is less than a preset threshold value and power is not inputted to the first power input port, the power controller may be driven using a portion of the power inputted to the second power input port and may charge the battery pack with another portion of the power.

In accordance with an embodiment, when the charge level of the battery pack is equal to or higher than a preset threshold value, the power controller may be driven using charge power of the battery pack and may supply power inputted to the first power input port to the battery pack to charge the battery pack, and the power controller may select the battery pack as the source to supply to the power output port.

In accordance with an embodiment, the battery management unit may supply power to a Master Unit (MU), which receives an RF signal transmitted from the base station and transmits the received RF signal to a terminal, through the power output port.

In accordance with an embodiment, the master unit may include a housing mounted with at least one transceiver unit for transmitting and receiving a signal between the base station and the terminal, the power collection unit and the battery management unit being mounted in or dismounted from the housing.

In accordance with an embodiment, when a plurality of power collection units and one battery management unit are mounted in the housing, power collected by the plural power collection units may be stored in the battery pack of the one battery management unit.

### Advantageous Effects

In accordance with the present disclosure, the energy consumption efficiency can be improved by collecting energy using a high-output RF signal of a base station and by utilizing the collected energy as an auxiliary power source of a distributed antenna system.

In addition, an equipment can be minimized by suppressing heat generation from a Point Of Interface, and thus, the manufacturing cost of the equipment can be reduced.

### DESCRIPTION OF DRAWINGS

FIG. 1 is a block diagram illustrating a general state in which a point of interface is installed:

FIG. 2 illustrates a block diagram of a general distributed antenna system:

FIG. 3 illustrates a block diagram of an existing point of interface:

FIG. 4 illustrates a block diagram of a point of interface according to an embodiment of the present disclosure:

FIG. 5 illustrates the appearance of a master unit according to an embodiment of the present disclosure; and

FIG. 6 illustrates a step-by-step flowchart of an operation method of a battery management unit according to an embodiment of the present disclosure.

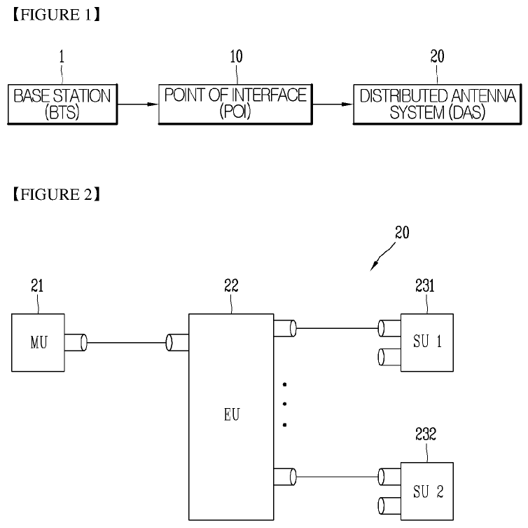

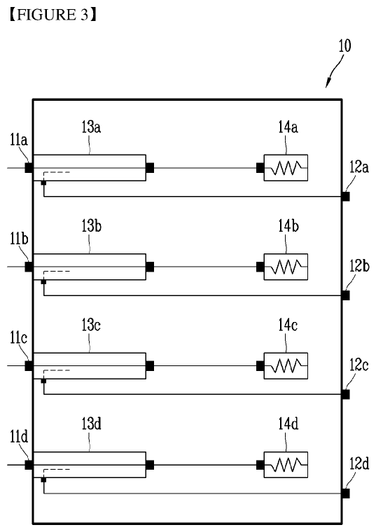

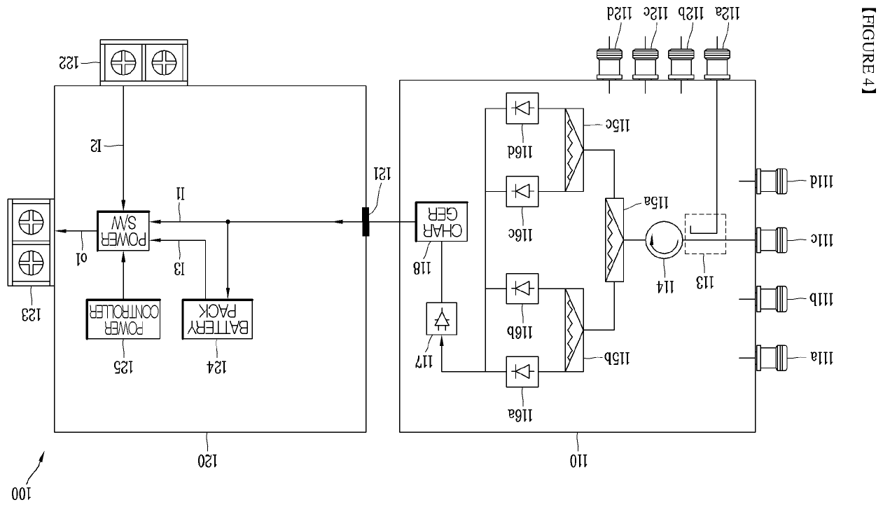

### BEST MODE

Hereinafter, the present disclosure will be described in detail by explaining exemplary embodiments of the disclosure with reference to the attached drawings. The same reference numerals in the drawings denote like elements, and a repeated explanation thereof will not be given. In addition, the suffixes “unit” and “part” of elements herein are used for convenience of description and thus can be used interchangeably and do not have any distinguishable meanings or functions. In the following description of the present disclosure, a detailed description of known functions and configurations incorporated herein will be omitted when it may make the subject matter of the present disclosure unclear. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms first, second, third etc. may be used herein to describe various elements, these elements should not be limited by these terms.

These terms are only used to distinguish one element from another element.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The expression of singularity in the present specification includes the expression of plurality unless clearly specified otherwise in the context.

Also, the terms such as “include” or “comprise” may be construed to denote a certain characteristic, number, step, operation, component, or a combination thereof in the specification, but may not be construed to exclude the presence of or a possibility of addition of one or more other characteristics, numbers, steps, operations, components, or combinations thereof.

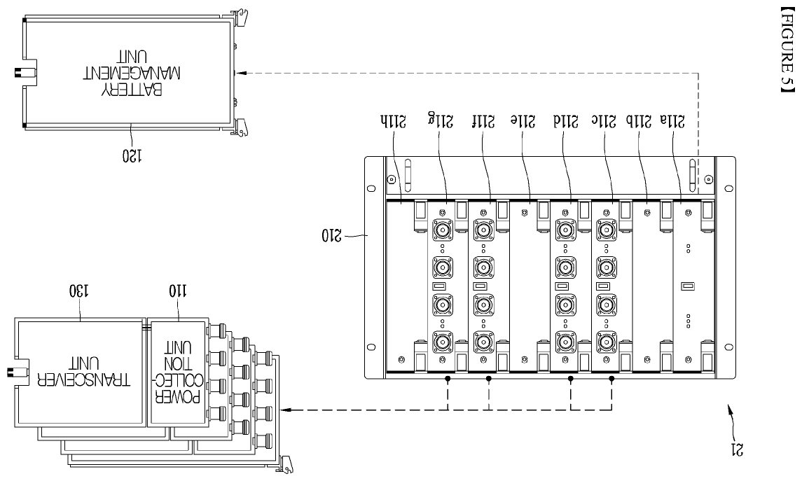

FIG. 4 illustrates a block diagram of a point of interface according to an embodiment of the present disclosure.

As shown in FIG. 4, at least one point of interface 100 according to an embodiment of the present disclosure may be installed between a base station 1 and a distributed antenna system 20.

The point of interface 100 may connect communication between the base station 1 and the distributed antenna system 20 and, for this, may include the power collection unit 110 that includes first ports 111a to 111d connected to the base station 1 and the second ports 112a to 112d connected to the distributed antenna system 20. Here, the point of interface 100 may further include a battery management unit 120 provided with a battery pack 124 for collecting and storing energy from a high-output RF signal that is input from the base station 1.

According to an embodiment of the present disclosure, the power collection unit 110 may collect energy using a high-output RF signal of the base station 1, and the collected energy may be stored in the battery pack 124 of the battery management unit 120, and then the battery management unit 120 may provide an auxiliary power source to an external device, specifically the distributed antenna system 20, to improve energy consumption efficiency.

As described below, the power collection unit 110 and the battery management unit 120 may be implemented to be physically separated from each other. Each of the power collection unit 110 and the battery management unit 120 may be mounted or dismounted to be connected or disconnected.

Hereinafter, respective components are described in detail.

The power collection unit 110 may receive an input of an RF signal that is output from the base station 1, connected to the first ports 111a to 111d, through the first ports 111a to 111d, and a coupler 113 may distribute a portion of the high-output RF signal, which is input through the first ports 111a to 111d, without affecting an original signal to provide a low-power RF signal to the second ports 112a to 112d.

That is, a portion of power passing through a main transmission path by coupling between adjacent lines using lines that is disposed close to the main transmission path connected to the first ports 111a to 111d may be distributed to the coupler 113, and the distributed RF signal (hereinafter, abbreviated as “sub RF signal”) may be provide to the second ports 112a to 112d.

Here, the amount of power to be distributed may be controlled depending upon the lengths of the lines disposed close to the main transmission path and a distance between the lines, without specific limitation.

A high-level main RF signal that is connected to the first ports 111a to 111d and passes through the coupler 113 without being distributed by the coupler 113 may be transmitted to rectifiers 116a to 116d. Here, For example, an RF signal introduced from the base station 1 through the first ports 111a to 111d may have a high power of about +43 dbM.

In other words, since a sub RF signal distributed by the coupler 113 and provided to the second ports 112a to 112d is a low-level power and the remaining high-level main RF signal, except for the low-level power, is rectified and charged in the battery pack 124 of the battery management unit 120, most of high-level power that is output from the base station 1 may be charged. In addition, even if the battery management unit 120 is separated from the power collection unit 110, connection between the base station 1 and the distributed antenna system 20 may be maintained. Here, a low-power RF signal provided to the second ports 112a to 112d may have, for example, a power of about 0 dbM.

According to an embodiment of the present disclosure, an attenuator (not shown) may be provided between the coupler 113 and the second ports 112a to 112d. The attenuator is preferably a variable attenuator. Preferably, the attenuator lowers the level of an input signal to have a constant level of output.

According to still another embodiment, a thermoelectric element may be provided to face the attenuator, and may generate a small amount of power using heat generated in a process in which the attenuator lowers the level of signal.

The thermoelectric element may be connected to a combine element 117 to charge the battery pack 124 of the battery management unit 120 with a small amount of power generated through a charger 118.

Meanwhile, a signal isolator 114 may be provided at the rear of the coupler 113 connected to the first ports 111a to 111d of the power collection unit 110 such that the main RF signal that passes through the coupler 113 proceeds in only one direction, i.e., not to be reflected to the first ports 111a to 111d.

In other words, the signal isolator 114 may be provided at a rear end of the coupler 113 to prevent reflection loss (or reverse-direction loss) due to signal reflection.

In addition, since the main RF signal on the main transmission path which has passed through the coupler 113 has a predetermined waveform, the rectifiers 116a to 116d may be included to rectify the RF signal into a DC signal. The rectifiers 116a to 116d of the present disclosure may include a rectifying module for half-wave or full-wave rectifying an RF signal having a waveform: a smoothing module for smoothing a rectified signal using LPF, etc.,; and the like, without specifically limited thereto.

According to an embodiment of the present disclosure, since the RF signal on the main transmission path of the power collection unit 110 has high output and the rectifiers 116a to 116d rectifying for the RF signal have a predetermined capacity, a plurality of rectifiers 116a to 116d are preferably provided in the power collection unit 110 for the normal operation of the rectifiers 116a to 116d.

The number of the rectifiers 116a to 116d included in the power collection unit 110 may vary depending upon the capacity of the rectifiers 116a to 116d. For example, the number of the rectifiers 116a to 116d may be an even number of four, but the present disclosure is not specifically limited thereto.

To distribute the high-output RF signal to each of the plural rectifiers 116a to 116d, one or more signal distributers 115a to 115c may be included.

The signal distributers 115a to 115c may distribute and output the power of an inputted main RF signal to two or more. The signal distributers 115a to 115c may divide and output the inputted power into, for example, two or more without affecting the inputted main RF signal. When distributed to the rectifiers 116a to 116d that are more than the output number of the signal distributers 115a to 115c, the plural signal distributers 115a to 115c may be hierarchically connected.

For example, when the signal distributers 115a to 115c distribute the inputted power to two and the number of the rectifiers 116a to 116d in the power collection unit 110 is four, the three signal distributers 115a to 115c may be divided into two layers and hierarchically connected, as shown in FIG. 4.

In conclusion, the high-output RF signal on the main line may be distributed to a plurality of signals by the signal distributers 115a to 115c and applied to the rectifiers 116a to 116d, and the rectifiers 116a to 116d may rectify the distributed RF signals into DC signals.

The DC signals rectified by the plural rectifiers 116a to 116d may be summed by the combine element 117 again, and the summed DC signal may be applied to the charger 118.

The charger 118 severs to transmit the applied DC signal to the battery management unit 120. To charge the battery pack 124 with power, a converter for transforming (boosting or reducing) the voltage of the applied DC signal, etc. may be included.

According to an embodiment of the present disclosure, the power collection unit 110 may be connected to the battery management unit 120 including the battery pack 124, via the charger 118.

The battery pack 124 may be a rechargeable DC battery and may include a plurality of battery cells connected in series and/or in parallel. Accordingly, the DC signal may be applied to the first power input port 121 of the battery management unit 120 through the charger 118 of the power collection unit 110, and the DC signal inputted through the first power input port 121 may be applied to the battery pack 124 to charge the battery pack 124 with power.

The power charged to the battery pack 124 may supply power to an external electronic device through a power output port 123.

The present disclosure does not specifically limit a target connected to the power output port 123 to receive power, but, according to a preferred embodiment, the distributed antenna system 20, specifically the master unit 21, may be connected to the power output port 123, and the power stored in the battery pack 124 may be used as an auxiliary power source of the master unit 21.

Meanwhile, the battery management unit 120 according to an embodiment of the present disclosure may include a second power input port 122 to which another external power is inputted, in addition to the first power input port 121 to which power is inputted from the charger 118: and the power output port 123 that outputs power to the outside of the battery management unit 120.

External commercial power may be supplied to the second power input port 122, but the power supplied to the base station 1 is branched and supplied to the second power input port 122 according to an embodiment of the present disclosure.

Accordingly, the battery management unit 120 should continuously output power through the power output port 123, but when the power stored in the battery pack 124 is less than a preset threshold value, the power controller 125 may select a source of power outputted through the power output port 123 as the second power input port 122 using the power switch 126.

That is, the power controller 125 may select any one source of the battery pack 124, the first power input port 121 and the second power input port 122 using the power switch 126 and may supply the power of the selected source to the power output port 123.

According to a specific embodiment the power controller 125 of the battery management unit 120 may select a source of power to be outputted through the power output port 123 according to any one of the charge level of the battery pack 124, whether the power collection unit 110 (or the charger 118) is connected to the first power input port 121, and whether external power is inputted through the second power input port 122.

For example, as shown in the drawings, one side of the power switch 126 may be connected with a first input line I1 to which power is applied from the first power input port 121, a second input line 12 to which power is applied from the second power input port 122, and a third input line 13 to which power is applied from a battery pack 124, and another side thereof may be connected with an output line O1 for providing power to the power output port 123 so that any one of the first to third input lines I1 to 13 selected by the power controller 125 may be connected to the output line O1.

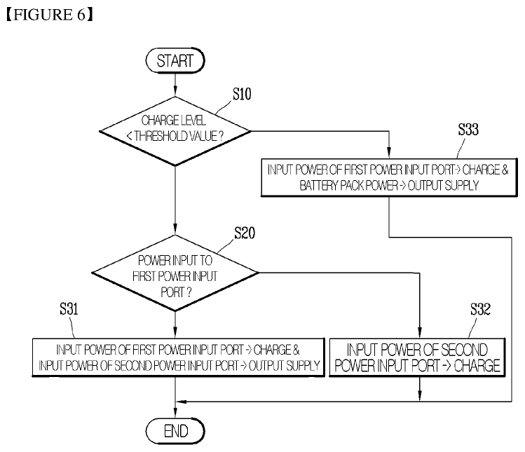

Specifically, FIG. 6 illustrates a step-by-step flowchart of an operation method of a battery management unit according to an embodiment of the present disclosure.

As shown in FIG. 6, the power controller 125 according to an embodiment of the present disclosure may measure the charge level of the battery pack 124 and may compare the charge level of the battery pack 124 with a preset threshold value (S10).

Here, the power controller 125 may determine (S20) whether power is inputted through the first power input port 121 when the charge level of the battery pack 124 is less than the preset threshold value, and may apply the input power through the first power input port 121 to the battery pack 124 to charge the battery pack 124 when the input power through the first power input port 121 is detected. Preferably, the operation of the power controller 125 is maintained using a portion of the power inputted through the first power input port 121.

In addition, when it is desired to continuously output power through the power output port 123, the power controller 125 may supply the power inputted into the second power input port 122 to the power output port 123 using the power switch 126 (S31) because the charge level of the battery pack 124 is low.

On the contrary, when the charge level of the battery pack 124 is less than the preset threshold value, but the power input through the first power input port 121 is not detected according to an embodiment of the present disclosure, a portion of the power inputted into the second power input port 122 may be supplied to the battery pack 124 to charge the battery pack 124, and another portion of the power may be supplied to the power controller 125 such that the operation of the power controller 125 is maintained (S32).

Here, when it is desired to continuously output power through the power output port 123, the power controller 125 may select the battery pack 124 as a source using the power switch 126 and may supply pre-stored power to the outside through the power output port 123 while charging the battery pack 124.

On the contrary, when the charge level of the battery pack 124 is equal to or higher than a preset threshold value according to an embodiment of the present disclosure, the power controller 125 may select the battery pack 124 as a source using the power switch 126 and may supply the power charged in the battery pack 124 to the power output port 123. A portion of the power stored in the battery pack 124 may be supplied to the power controller 125 such that the operation of the power controller 125 is maintained (S33).

Here, when the battery pack 124 is not fully charged, the power inputted through the first power input port 121 may be supplied to the battery pack 124 so that the battery pack 124 may be additionally charged.

Meanwhile, the point of interface 100 according to an embodiment of the present disclosure may collect energy from the high-output RF signal of the base station 1 unlike the existing POI 10 to charge the modularized battery management unit 120. In addition, since the power collection unit 110 for transmitting a signal coupled with a high-output RF signal to the distributed antenna system 20, specifically the master unit 21, is also modularized, heat generation in the existing POI 10 may be suppressed, and thus, the equipment may be minimized.

FIG. 5 illustrates the appearance of a master unit according to an embodiment of the present disclosure. As shown in FIG. 5, the master unit 21 generally includes at least one transceiver unit 130 for relaying a signal, i.e., for transmitting and receiving a signal, to allow communication between the terminal UE and the base station 1. Here, the transceiver unit 130 may be implemented in the form of a card implement and may be detachably mounted by slidably moving forward and backward toward slots 211a to 211h provided in an enclosure-shaped housing 210.

Accordingly, the modularized power collection unit 110 and battery management unit 120 may be implemented in the form of a card mountable in the slots 211a to 211h of the housing 210 to be mounted in or dismounted from the slots 211a to 211h in the housing 210 of the master unit 21.

Here, the power collection unit 110 is preferably implemented in the form of a single card together with the transceiver unit 130 to transmit an RF signal received from the base station 1 to the transceiver unit 130, regardless of the battery management unit 120, to be mounted in the slots 211a to 211h.

Unlike the power collection unit 110, the battery management unit 120 is preferably implemented to be arbitrarily connected to or disconnected from the power collection unit 110 so as not to affect the operation of the power collection unit 110.

That is, the battery management unit 120 may be implemented in the form of a separate card, which is separated from the power collection unit 110 or the transceiver unit 130, to be individually mounted in or dismounted from the slots in the housing 210 of the master unit 21.

By mounting the battery management unit 120 in the housing 210 of the master unit 21, the battery management unit 120 may be connected to the power collection unit 110, specifically the charger 118 of the power collection unit 110. In addition, the power output port 123 of the battery management unit 120 is preferably connected to an auxiliary power input unit (not shown) of the master unit 21 such that the power charged in the battery pack 124 of the battery management unit 120 is supplied as an auxiliary power source to the master unit 21.

Meanwhile, a plurality of power collection units 110 may be mounted in the housing 210 of the master unit 21, as described above. In this case, the plural power collection units 110 may be connected to a single battery management unit 120.

Therefore, the battery pack 124 of the single battery management unit 120 may be intensively charged with power collected by the plural power collection units 110, thereby increasing a charging speed, or the battery pack 124 may be continuously charged even when any one of the plural power collection units 110 operates.

Although embodiments of the present disclosure have been described with reference to the accompanying drawings, those skilled in the art will understand that the present disclosure can be easily changed or modified into other specified forms without change or modification of the technical spirit or essential characteristics of the present disclosure.

It should be understood that the scope of the present disclosure is defined by the following claims, rather than the above detailed description and the disclosure is to cover all modifications, equivalents, and alternatives falling within the spirit and scope of the disclosure as defined by the claims.

1. A point of interface for connecting communication between a base station and a distributed antenna system, comprising:
a power collection unit provided with first ports connected to the base station; and
second ports connected to the distributed antenna system; and
a battery management unit comprising a battery pack,
wherein the power collection unit comprises:
a rectifier for rectifying a signal transmitted through the first ports;
couplers for coupling the signal transmitted through the first ports to transmit an obtained sub RF signal to the second ports; and
a charger for charging the battery pack with power using the rectified signal.

2. The point of interface according to claim 1, wherein the rectifier comprises a plurality of rectifier elements for rectifying a main RF signal, other than the sub RF signal distributed by the couplers, among signals transmitted through the first ports to DC signals, and
the power collection unit comprises at least one signal distributer for distributing the main RF signal, which passes through the couplers, to the plural rectifier elements; and a combine element for summing the plural DC signals rectified by the plural rectifier elements.

3. The point of interface according to claim 2, wherein the power collection unit is provided at a rear end of the couplers and further comprises a signal isolator for allowing the main RF signal, which passes through the couplers, to proceed only in one direction.

4. The point of interface according to claim 1, wherein a plurality of distribution elements are provided between the couplers and the plural rectifier elements such that the distribution elements are hierarchically connected to each other.

5. The point of interface according to claim 1, wherein the battery management unit comprises:
a first power input port inputted from the charger of the power collection unit;
a second power input port to which power that is supplied to the base station and divided is inputted;
a power output port for outputting power outward; and
a power controller for selecting any one source of the battery pack, the first power input port and the second power input port and for supplying power of the selected source to the power output port.

6. The point of interface according to claim 5, wherein the power controller selects the source according to a charge level of the battery pack, whether the power collection unit is connected to the first power input port, and whether external power is inputted through the second power input port.

7. The point of interface according to claim 5, wherein, when the charge level of the battery pack is less than a preset threshold value and power is inputted to the first power input port, the power controller is driven using a portion of the power inputted to the first power input port and charges the battery pack with another portion of the power, and
the power controller supplies power inputted to the second power input port to the power output port.

8. The point of interface according to claim 5, wherein, when the charge level of the battery pack is less than a preset threshold value and power is not inputted to the first power input port, the power controller is driven using a portion of the power inputted to the second power input port and charges the battery pack with another portion of the power.

9. The point of interface according to claim 5, wherein, when the charge level of the battery pack is equal to or higher than a preset threshold value, the power controller is driven using charge power of the battery pack and supplies power inputted to the first power input port to the battery pack to charge the battery pack, and
the power controller selects the battery pack as the source to supply to the power output port.

10. The point of interface according to claim 5, wherein the battery management unit supplies power to a Master Unit (MU), which receives an RF signal transmitted from the base station and transmits the received RF signal to a terminal, through the power output port, and
the master unit comprises a housing mounted with at least one transceiver unit for transmitting and receiving a signal between the base station and the terminal,
the power collection unit and the battery management unit being mounted in or dismounted from the housing.

11. The point of interface according to claim 10, wherein, when a plurality of power collection units and one battery management unit are mounted in the housing, power collected by the plural power collection units is stored in the battery pack of the one battery management unit.
